(19) United States
(12) Patent Application Publication
(10) Pub. No.: US 2020/0039627 A1
(43) Pub. Date: Feb. 6, 2020

(54) FITTING FOR ATTACHING THE HORIZONTAL TAIL STABILIZER OF AN AIRCRAFT

(71) Applicant: Airbus Operations, S.L., Getafe (ES)

(72) Inventor: Manuel JURADO MEDINA, Getafe (ES)

(21) Appl. No.: 16/526,507

(22) Filed: Jul. 30, 2019

(30) Foreign Application Priority Data
Aug. 1, 2018 (EP) 18382583.5

(51) Int. Cl. B64C 1/26; B64C 5/02; B64F 5/10

(52) U.S. Cl. CPC B64C 1/26; B64F 5/10; B64C 5/02

(57) ABSTRACT

A fitting for attaching the horizontal tail stabilizer of an aircraft, allowing the formation of a lighter component, without a fatigue failure mode and with a significant reduction in the installation time. The fitting comprises: a core piece having a regular thickness, the core piece having a U configuration, according to a plan view, thereby being composed of two lateral areas and a central area located between the lateral areas, at least one central reinforcement having a regular thickness and joined to one side of the central area and comprising a flange located on an inner edge of the core piece, at least two lateral reinforcements having a regular thickness and each lateral reinforcement being joined to one side of a different lateral area and comprising a flange located on the inner edge of the core piece.

### CROSS-REFERENCES TO RELATED APPLICATIONS

This application claims the benefit of the European patent application No. 18382583.5 filed on Aug. 1, 2018, the entire disclosures of which are incorporated herein by way of reference.

### FIELD OF THE INVENTION

A first aspect of the present invention relates to a fitting for attaching the horizontal tail stabilizer of an aircraft and more particularly to fittings manufactured in composite, having application in the technical field of aeronautics, allowing the formation of a lighter component, without fatigue failure mode, thus allowing longer inspection intervals and with a significant reduction in the installation time.

The invention further relates to a horizontal tail plane of an aircraft comprising a fitting according to the invention, as well as to an aircraft comprising such horizontal tail plane.

A second aspect of the present invention relates to a process for forming a fitting according to the first aspect of the invention.

### BACKGROUND OF THE INVENTION

Nowadays, the use of composites, such as the CFRP (Carbon Fiber Reinforced Plastic), is known in a large number of components of an aircraft. Such components are lighter than aluminum, although their manufacture is complex, making them more expensive than aluminum components.

For that reason, the fittings used for attaching horizontal tail stabilizers are produced with metallic materials. As represented in FIG. 1, fittings for attaching the pivoting horizontal stabilizers, not shown, to the rear surface (A) of the horizontal tail plane, hereinafter “the HTP”, comprise a rear support (B) having a triangular configuration whose inner edge contacts the rear surface (A) of the HTP. Each of the ends of the rear support (B) close to the rear surface (A) are respectively connected to a lower (C) and an upper support (D) fitting by means of bolts, self-block nuts and bushings (E). The lower (C) and upper supports (D) are configured to contact each of the lower and upper main surfaces (F) of the HTP.

Nevertheless, metallic fittings have several drawbacks to be taken into account. First of all, metallic fittings have problems of cracks and fatigue, therefore, in the particular case of HTP pivot fittings, a lot of assembled fittings are necessary, which leads to a complex and expensive installation.

Furthermore, given the installation method of a metallic fitting as represented in FIG. 1, it can only be mounted during manufacturing of the airplane, thus, such fitting cannot be installed in an already manufactured aircraft.

### SUMMARY OF THE INVENTION

A first aspect of the present invention relates to a fitting for attaching the horizontal tail stabilizer of an aircraft. The invention overcomes the above mentioned drawbacks.

It is an object of the invention to provide a fitting that allows installation not only during the production of the aircraft but also in an already manufactured aircraft given that the installation takes place at the outer external side of the HTP. Further to that mounting option, the installation of fasteners can be made through the manholes providing interior access.

Furthermore, it is an object of the invention to provide a fitting resistant to cracks and fatigue, at a reduced cost. Composite carbon fiber fittings have no fatigue failure mode and inspection intervals are longer, with benefits for airlines.

Another object of the invention is to provide a lighter fitting. Composite carbon fiber fittings are lighter than metal fittings. For HTP pivot fittings, only one fitting is installed, with reduced installation time.

According to the invention, a fitting for attaching the horizontal tail stabilizer of an aircraft comprises:
a core piece having a regular thickness, the core piece having a U configuration, according to a plan view, thereby being composed by two lateral areas, i.e., arms, and a central area located between the lateral areas,
at least one central reinforcement having a regular thickness and joined to one side of the central area and comprising a flange, i.e., a tab, located in an inner edge of the core piece, configured to contact the rear surface (A) of the HTP,
at least two lateral reinforcements having a regular thickness and each lateral reinforcement being joined to one side of a different lateral area and comprising a flange located in the inner edge of the core piece, configured to contact the main surfaces (F), upper and lower, of the HTP.

The fitting is formed as one single integral or unitary piece.

According to a preferred embodiment, the core piece and the reinforcements are made of composite carbon fiber.

A second aspect of the present invention relates to a process for forming a fitting as defined above, the process comprising:

a) cutting a core piece, at least one central reinforcement and at least two lateral reinforcements from a composite carbon fiber tape,

b) folding flanges of the reinforcements in a press forming step,

c) arranging the reinforcements in side contact with the core piece into a mold to conform to a final geometry and ensure a step of co-curing in an autoclave, thus forming a unitary piece.

### BRIEF DESCRIPTION OF THE DRAWINGS

For a better comprehension of the invention, the following drawings are provided for illustrative and non-limiting purposes, wherein:

FIG. 1 shows a metallic fitting of the state of the art; view a) shows a perspective view of the fitting installed in the rear surface of the HTP, view b) shows a perspective view of the two independent elements forming the upper support, together with a bushing, and view c) shows an exploded view of the metallic fitting.

FIG. 2 shows a perspective view of a fitting according to the invention installed in the rear surface of the HTP.

FIG. 3 shows a perspective view of the fitting from the side configured to be in contact with the HTP.

FIG. 4 schematically shows a plan view of the components forming the fitting of the invention when cut from laminated rectangular stacking raw plate and prior to be folded and co-cured together forming a unitary piece.

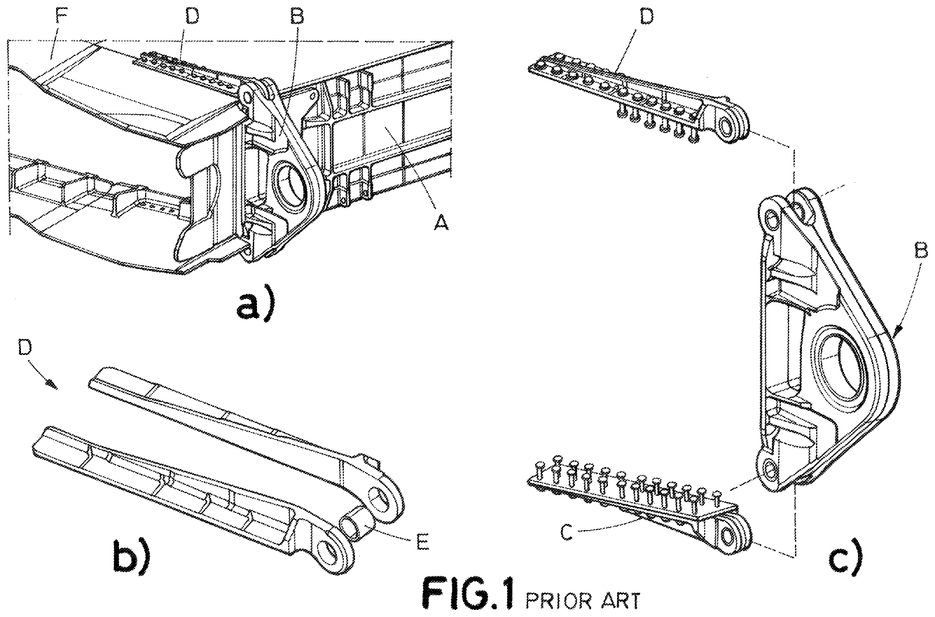

### DETAILED DESCRIPTION OF THE PREFERRED EMBODIMENTS

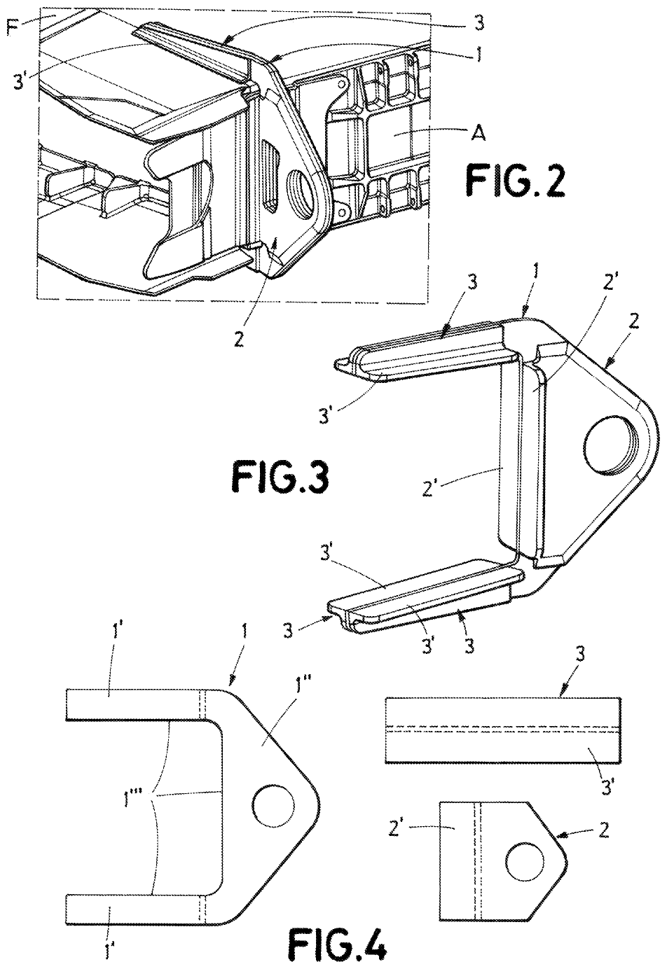

In a preferred embodiment of the invention, shown in FIGS. 2-4, the fitting for attaching the horizontal tail stabilizer of an aircraft comprises:
a core piece (1) formed from tape having a regular thickness, the core piece (1) having a U configuration, according to a plan view, thereby being composed by two lateral areas (1′) and a central area (1″) located between the lateral areas (1′),
two central reinforcements (2), joined at both sides of the central area (1″) of the core piece (1), formed from a tape having a regular thickness and joined to one side of the central area (1″). Each central reinforcement (2) comprises a flange (2′) located in an inner edge (1′″) of the core piece (1), the geometry of the joined area of the at least one central reinforcement (2) being similar to, i.e., such as, the geometry of the central area (1″) of the core piece (1), preferably not exceeding its perimeter,
four lateral reinforcements (3), joined at both sides of each lateral area (1′) of the core piece (1), formed from a tape having a regular thickness and each lateral reinforcement (3) being joined to one side of a different lateral area (1′) and comprising a flange (3′) located in the inner edge (1′″) of the core piece (1), the geometry of the joined area of each lateral reinforcement (3) being such as the geometry of the lateral area (1′) of the core piece (1), preferably not exceeding its perimeter.

The core piece (1) and the reinforcements (2, 3) are made of composite carbon fiber.

The reinforcements (2, 3) are joined to the core piece (1) by co-curing in an autoclave, thus forming a unitary single piece.

The core piece (1) and the reinforcements (2, 3) are formed by cutting one composite carbon fiber tape, thereby having the same thickness.

The flanges (2′, 3′) are formed by folding the reinforcements (2, 3) cut from at least one tape.

The flange (2′) of each central reinforcement (2) is oriented so as to allow the contact with a rear surface (A) of a horizontal tail plane, i.e., perpendicular to the plane of the tape forming the core piece (1). The flange (3′) of each lateral reinforcement (3) is oriented so as to allow the contact with a main surface (F) of the horizontal tail plane, i.e., configured to contact the upper and lower surfaces of the HTP.

Preferably the central area (1″) and the joined area of the central reinforcement (2) have a triangular configuration.

Furthermore, according to a preferred embodiment, lateral areas (1′) and the lateral reinforcements (3) decreases in width upon their ends.

As represented in FIGS. 2-4, the central area (1″) and the central reinforcement have corresponding holes for the function of the fitting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fitting for attaching a horizontal tail stabilizer of an aircraft, comprising:
a core piece having a regular thickness, the core piece having a U configuration, according to a plan view, thereby being composed of two lateral areas and a central area located between the lateral areas,
at least one central reinforcement having a regular thickness and joined to one side of the central area and comprising a flange located at an inner edge of the core piece,
at least two lateral reinforcements having a regular thickness and each lateral reinforcement being joined to one side of a different lateral area and comprising a flange located at the inner edge of the core piece.

2. The fitting according to claim 1, wherein the core piece is formed from a tape.

3. The fitting according to claim 1, wherein the at least one central reinforcement is formed from a tape and a geometry of a joined area of the at least one central reinforcement conforming to a geometry of the central area of the core piece.

4. The fitting according to claim 1, wherein the at least two lateral reinforcements are formed from a tape and a geometry of a joined area of each lateral reinforcement conforming to a geometry of the two lateral areas of the core piece.

5. The fitting according to claim 1, wherein the core piece and the at least two lateral reinforcements are made of composite carbon fiber.

6. The fitting according to claim 5, wherein the at least two lateral reinforcements are joined to the core piece by co-curing in an autoclave.

7. The fitting according to claim 1, wherein the core piece and the at least two lateral reinforcements are formed by cutting one composite carbon fiber tape.

8. The fitting according to claim 1, wherein the flanges are formed by folding the at least two lateral reinforcements cut from at least one tape.

9. The fitting according to claim 1, wherein the flange of the at least one central reinforcement is oriented so as to allow contact with a rear surface of a horizontal tail plane, and the flange of each of the at least two lateral reinforcements is oriented so as to allow contact with a main surface of the horizontal tail plane.

10. A horizontal tail plane of an aircraft comprising a fitting according to claim 1.

11. An aircraft comprising a horizontal tail plane according to claim 10.

12. A process for forming a fitting according to claim 1, comprising:
a) cutting a core piece, at least one central reinforcement and at least two lateral reinforcements from a composite carbon fiber tape,
b) folding flanges of the at least two lateral reinforcements in a press forming step,
c) arranging the at least two lateral reinforcements in side contact with the core piece in a mold to conform to a final geometry and ensure a step of co-curing in an autoclave, thus forming a unitary piece.
